(19) United States
(12) Patent Application Publication
(10) Pub. No.: US 2026/0319091 A1
(43) Pub. Date: Oct. 15, 2026

(54) Integrated Circuit for a Laser Distance Measuring Device

(71) Applicant: Robert Bosch GmbH, Stuttgart (DE)

(72) Inventors: Bernd Schmidtke, Leonberg (DE); Paul Schliffke, Bietigheim-Bissingen (DE); Stefan Noe, Stuttgart (DE); Uwe Skultety-Betz, Leinfelden-Echterdingen (DE)

(21) Appl. No.: 19/643,106

(22) Filed: Apr. 9, 2026

(30) Foreign Application Priority Data
Apr. 11, 2025 (DE) 10 2025 114 333.1

(51) Int. Cl. G01S 17/32; G01S 7/481; G01S 7/4915

(52) U.S. Cl. CPC G01S 17/32; G01S 7/4814; G01S 7/4816; G01S 7/4915

(57) ABSTRACT

An integrated circuit for a laser distance measuring device includes (i) a first sensor array, wherein the first sensor array is provided for sensing a light of a laser diode of the laser distance measuring device reflected by an object, (ii) a second sensor array, wherein the second sensor array is provided for sensing the light of the laser diode reflected by an internal reference object, wherein the second sensor array has a smaller size than the first sensor array, and (iii) barrier element, wherein the barrier element is arranged between the first sensor array and the second sensor array to counteract light transmission between the first sensor array and the second sensor array. A laser distance measuring device as well as a method for performing a laser distance measurement, a computer program, a device and a storage medium for this purpose are also disclosed.

This application claims priority under 35 U.S.C. § 119 to patent application no. DE 10 2025 114 333.1, filed on Apr. 11, 2025 in Germany, the disclosure of which is incorporated herein by reference in its entirety.

The disclosure relates to an integrated circuit for a laser distance measuring device. The disclosure further relates to a laser distance measuring device as well as a method for performing a laser distance measurement, a computer program, a device and a storage medium for this purpose.

### BACKGROUND

Laser distance measuring devices may be used to measure distances based on the time of flight of light. Since electro-optical properties of the light sources and/or receivers do not permit an absolute determination of the time of flight from electrical signals alone, a reference measurement is usually carried out over a known path within the laser distance measuring device. This can be implemented by way of switchable optical elements, two synchronous light sources or two synchronous receivers, which have varying additional costs.

### SUMMARY

The subject of the disclosure is an integrated circuit, a laser distance measurement device, a method, a computer program, a device, as well as a computer-readable storage medium with the features set forth below. Further features and details of the disclosure result from the description and the drawings. Features and details which are described in connection with the integrated circuit according to the disclosure naturally also apply in connection with the laser distance measurement device according to the disclosure, the method according to the disclosure, the computer program according to the disclosure, the device according to the disclosure as well as the computer-readable storage medium according to the disclosure, and vice versa in each case, so that a reciprocal reference is always possible with regard to the disclosure of the disclosure.

The subject matter of the disclosure is in particular an integrated circuit, in particular an application-specific integrated circuit (ASIC) for a laser distance measuring device, comprising:
a first sensor array, which may also be referred to and understood as a target array in the context of the present disclosure, wherein the first sensor array is provided for sensing light of a laser diode of the laser distance measuring device reflected by an object,
a second sensor array, which may also be referred to and understood as a reference array in the context of the present disclosure, wherein the second sensor array is provided for sensing light of the laser diode reflected by an internal reference object, wherein the second sensor array has a smaller size than the first sensor array,
a barrier element, wherein the barrier element is arranged between the first sensor array and the second sensor array to counteract light transmission between the first sensor array and the second sensor array.

The smaller size is particularly provided such that light-sensitive surfaces and/or a number of light-sensitive elements, respectively pixels, of the first sensor array and the second sensor array are different in size and/or shape. The counteracting may also be understood as preventing or suppressing. The disclosure may enable cost-effective and less computationally intensive provision of a reference signal for laser distance measurement due to the smaller size of the second sensor array. Furthermore, a reduction in rejects due to statistical errors in the sensor arrays may also be provided. The rejects of microchips from semiconductor processes increase in particular with an increase in the chip surface area, because a process-dependent defect density is more likely to lead to failure of a chip. The effect of defects can also be reduced by way of redundancy or aggregation of multiple sensor elements.

In addition, it is advantageous if the barrier element is comprised of an opaque material, in particular plastic or metal. Thus, light transmission between the first sensor array and the second sensor array can be effectively counteracted.

It is also optionally conceivable that the integrated circuit further comprises a glass surface, wherein the glass surface is arranged over the first sensor array and the second sensor array to cover the first sensor array and the second sensor array with the glass surface. Thus, contamination and/or damage to the sensor arrays may advantageously be prevented.

Furthermore, within the scope of the disclosure, it is optionally possible for the glass surface to have an anti-reflective coating to increase light yield. In order to increase the light yield and reduce reflections in the glass surface, or between the glass and the sensor array surface, the anti-reflective coating of the glass surface is thus preferably provided. This particularly prevents reflections in a receiving wavelength range of the sensor arrays, i.e., in particular in a wavelength range of a laser diode of the laser distance measuring device.

Furthermore, it is optionally provided that the glass surface comprises a, preferably narrowband, color filter to block a defined light wavelength spectrum. Thus, advantageously, stray light outside the wavelength of the laser diode of the laser distance measuring device can be blocked.

It may be further possible for individual sensor surfaces of the first sensor array and/or the second sensor array to have a polygonal, in particular rectangular or square, shape.

In a further embodiment, it may be provided that the individual sensor surfaces of the first sensor array and/or the second sensor array are partially configured as macropixels, each comprising a plurality of subpixels, wherein the subpixels are connected to a common (pulse) line. Thus, a necessary area for (pulse) lines can be reduced and area utilization can be increased. Furthermore, light yield can thus advantageously be increased.

The subject of the disclosure is additionally a laser distance measuring device comprising at least one integrated circuit according to the present disclosure and a laser diode. Thus, the laser distance measuring device according to the disclosure has the same advantages as described in detail with respect to the integrated circuit according to the disclosure.

The subject of the disclosure is additionally a method of performing a laser distance measurement with a laser distance measuring device according to the present disclosure, comprising:
initiating emission of light by a laser diode of the laser distance measuring device toward an object and an internal reference object,
evaluating sensor data of a first sensor array and a second sensor array to determine a distance between the laser distance measuring device and the object.

Thus, the method according to the disclosure has the same advantages as described in detail with respect to the integrated circuit according to the disclosure.

It may be provided in the context of the disclosure that, as part of evaluating the sensor data, count results of a plurality pixels of the first sensor array and/or the second sensor array are added in phase to provide spatial averaging. In particular, the term “in phase” means that the count results of the plurality of pixels are added such that they do not interfere with, or cancel out, each other in their temporal or spatial phase. By way of spatial averaging, noise can be reduced and light yield can be increased to improve signal quality.

As a further advantage, it may be provided that the evaluation of the sensor data comprises:
calculating an energy, in particular light energy, and/or a signal vector based on count results of each pixel.

The signal vector may comprise a light intensity, a phase shift, and/or a sequence of measured values at different points in time. Thus, a more precise evaluation and laser distance measurement can be performed.

In a further embodiment, it may be provided that evaluating the sensor data comprises:
evaluating individual macropixels by way of a multiphase counter, e.g., an 8-phase counter, wherein a reading direction is preferably perpendicular to a parallax, in particular a parallax of an optical system of the laser distance measuring device.

A multiphase counter is in particular a digital counter that passes through a plurality of discrete phases before resetting and restarting. The multiphase counter may be implemented as a specific form of a ring counter or Johnson counter, wherein each phase may correspond to a certain state within the counter cycle. For example, the multiphase counter may receive a plurality of evenly distributed clock signals that are evenly phase-shifted with respect to one another to ensure uniform signal distribution. Parallax is in particular an apparent displacement of an object relative to a background as the point of observation changes. This phenomenon occurs, for example, when objects at different distances appear from different angles of view when viewed from different positions.

Another object of the disclosure is a computer program, in particular a computer program product, comprising instructions which, when the computer program is executed by at least one computer, cause the computer to carry out the method according to the disclosure. The computer program according to the disclosure thus brings about the same advantages as have been described in detail with reference to the method according to the disclosure.

The subject matter of the disclosure is also a device for data processing that is configured to execute the method according to the disclosure. The device can be at least one computer, for example, that executes the computer program according to the disclosure. The computer may have at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by at least one computer, prompt said computer program to carry out the method according to the disclosure. The storage medium is configured, for example, as a data memory such as a hard disk and/or a non-volatile memory and/or a memory card. The storage medium may, for example, be integrated in the computer.

Furthermore, the method according to the disclosure may also be executed as a computer-implemented method. Alternatively or additionally, at least one of the disclosed method steps may be computer-implemented and/or performed automatically.

### BRIEF DESCRIPTION OF THE DRAWINGS

Further advantages, features and details of the disclosure will be apparent from the following description, in which exemplary embodiments of the disclosure are described in detail with reference to the drawings. In this case, the features mentioned in the claims and in the description may in each case be essential to the disclosure individually or in any desired combination. It shows:

FIG. 1 a schematic illustration of a laser distance measurement device according to exemplary embodiments of the disclosure,

FIG. 2 a schematic illustration of a laser distance measurement device according to exemplary embodiments of the disclosure,

FIG. 3 a schematic illustration of an integrated circuit according to exemplary embodiments of the disclosure,

FIG. 4 a schematic illustration of a method, a device, a storage medium and a computer program according to exemplary embodiments of the disclosure.

### DETAILED DESCRIPTION

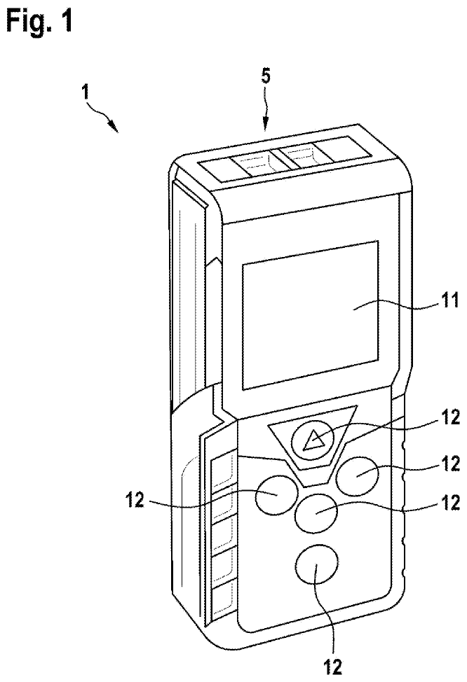

FIG. 1 shows a schematic illustration of a laser distance measurement device 1 according to exemplary embodiments of the disclosure. This comprises a laser diode 5, a display 11 and a plurality of control buttons 12.

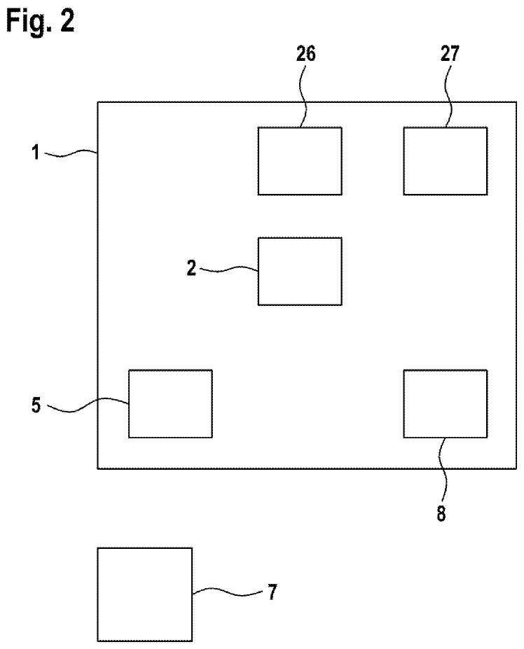

FIG. 2 shows a further schematic illustration of internal equipment of the laser distance measurement device 1 according to exemplary embodiments of the disclosure. This comprises a microcontroller 26 and a laser driver 27, as well as an (application-specific) integrated circuit 2. Furthermore, the laser distance measuring device 1 comprises a laser diode 5. Also shown are an object 7 and an internal reference object 8, which may be used in the context of laser distance measurement.

In particular, the laser distance measuring device 1 according to the disclosure uses an indirect time of flight (iToF) measurement. For example, the laser distance measuring device 1 operates by measuring a phase shift of a modulated light signal emitted by the laser distance measuring device 1 and reflected by a target object. The following is a description of how the indirect time of flight (iToF) measurement works. First, the laser diode 5 in the laser distance measurement device 1 can transmit intensity-modulated light, for example in the infrared or visible area, towards a target object 7. The modulation is in particular carried out with a sinusoidal or square wave. The intensity-modulated light subsequently strikes the target object 7 and is reflected back to the laser distance measuring device 1. The first sensor array 3 in the laser distance measuring device 1 may now receive the reflected light. Since the light takes a certain amount of time to travel the distance, there is a phase shift between the transmitted signal and the received signal. This phase shift between the transmitted signal and the received signal may then be measured. This phase shift is in particular proportional to the distance of the light traveled. The distance may then be calculated from the phase shift taking into account the wavelength of the modulation and the speed of light. It may further be provided that a reference phase is determined with the second sensor array 4 with a constant distance to an internal reference object 8 of the laser distance measuring device 1 to determine the phase shift based on a comparison to the reference phase.

The integrated circuit 2 is responsible in particular for laser control, i.e., for example, control of the laser diode 5, modulation, signal processing, phase measurement, and/or data transmission.

Thus, an emission from the laser diode 5 can be controlled by generating an amplitude modulation of a laser beam of the laser diode 5. This can ensure that the laser beam is transmitted with the correct frequency and phase position.

After receipt of a fraction of the transmitted laser light by the sensor arrays 3, 4, the received signal may be processed. This includes, for example, amplification, filtering and conversion of the received analog signal into a digital signal for further analysis. Furthermore, the phase shift between the transmitted signal and the received signal may be measured and optionally compared to the reference phase.

The digital conversion in the multiphase counters may allow the phase shift between the transmitted signal and the received signal to be analyzed.

A laser driver 27 in the laser system 1, or the laser distance measuring device, in particular, has the task of converting digital control signals into analog signals. The laser driver 27 preferably generates analog currents needed to modulate the laser diode 5. This control is critical for the emission of the laser beam with the desired modulation. By converting digital modulation commands into analog signals, the laser driver 27 can control the modulation of the laser beam. This may include pulsed light or a continuous wave of variable modulation frequency.

According to exemplary embodiments of the disclosure, a cost-effective provision of a reference signal for laser distance measurement as well as a reduction in rejects due to statistical errors in the sensor arrays 3, 4 may be achieved.

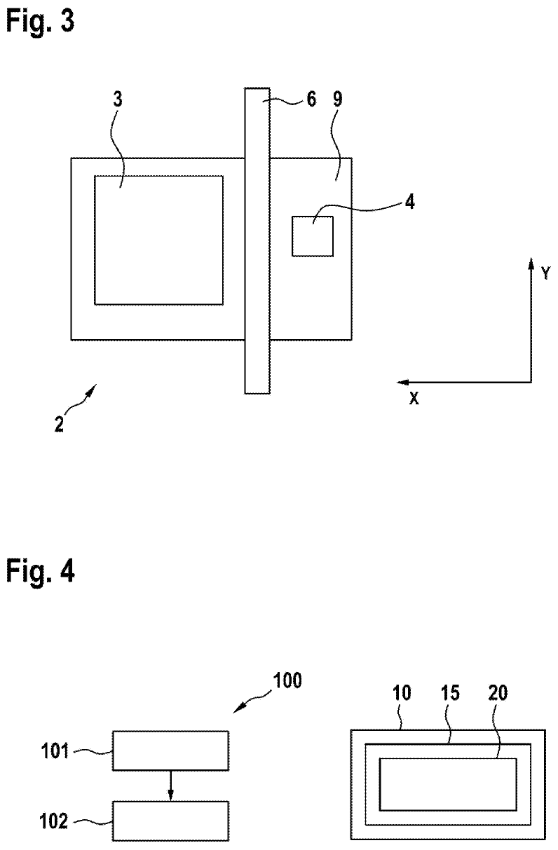

According to the disclosure, the sensor surfaces of the sensor arrays 3, 4 may be arranged on an (application-specific) integrated circuit (ASIC) 2 with the following characteristics. A schematic illustration of an integrated circuit 2 according to exemplary embodiments of the disclosure is shown in FIG. 3. The first (target) sensor array 3 and the second (reference) sensor array 4 are preferably located on the same integrated circuit 2 and receive the same time basis for the measurement. The first (target) sensor array 3 and the second (reference) sensor array 4 preferably have a defined minimum distance from each other to avoid, or at least reduce, optical crosstalk. This allows, for example, the installation of a barrier element 6 between the first (target) sensor array 3 and the second (reference) sensor array 4, i.e., in particular between a receiving path and a reference path of the laser distance measuring device 1.

Light-sensitive surfaces and/or a number of light-sensitive elements (pixels) of the first (target) sensor array 3 and the second (reference) sensor array 4 may be of different sizes and shapes. In particular, the size of the second (reference) sensor array 4 may be reduced compared to the first (target) sensor array 3 in order to save costs. Each light-sensitive element may be individually switched on and off for testing purposes and to improve signal quality in accordance with the disclosure. This, in particular, reduces the number of unusable sensors.

The count results of a plurality of pixels of a respective sensor array 3, 4 may be added together in phase on the integrated circuit 2 to achieve spatial averaging, reduce a quantity of transmitted data and simplify signal evaluation.

From the count results of each pixel, an energy and/or a signal vector may be calculated on the integrated circuit to reduce the quantity of transmitted data and to simplify signal evaluation.

According to the disclosure, the sensor arrays 3, 4 may be arranged in the (application-specific) integrated circuit (ASIC) 2 as follows:

In order to reduce optical crosstalk between the first (target) sensor array 3 and the second (reference) sensor array 4, the two optical channels are preferably separated by an optical barrier in the form of the barrier element 6. This may comprise an elastic element to improve the optical seal.

Preferably, the sensor arrays are covered with a glass surface 9, i.e., a glass pane, to prevent contamination and/or damage to the sensor arrays 3, 4. It is also conceivable that only one of the sensor arrays 3, 4 is covered by the glass surface 9.

In order to increase light yield and reduce reflections in the glass surface 9, or between the glass and the sensor array surface, an anti-reflective coating of the glass surface 9 is preferably provided, in particular in a receiving wavelength range of the sensor arrays 3, 4, i.e., in particular in a range of a wavelength of the laser diode 5 of the laser distance measuring device 1. In addition, the glass surface 9 may comprise a, preferably narrowband, color filter for blocking stray light outside the wavelength of the laser diode 5 of the laser distance measuring device 1.

The sensor arrays 3, 4 may preferably have a polygonal, in particular rectangular or square, shape, which is in particular divided into X*Y identical sensor elements (macropixels). In particular, X refers to pixels in the laser/parallax direction, and Y is perpendicular to it.

According to exemplary embodiments of the disclosure, a single evaluation of each macropixel can be performed by a multiphase counter. For a larger number of macropixels, a necessary area for pulse lines can consume a majority of the sensor arrays 3, 4, and the multiphase counters can occupy significant chip area. Preferably, the reading direction (Y) is perpendicular to the parallax (X) to allow for as large a parallax compensation as possible. A subset of a few pulse lines per X-position, i.e., a few macropixels (e.g., 3 out of 30), can be provided as a sensible compromise.

Since the number of multiphase counters is also limited, a subset of macropixels (activation pattern) may be selected for a particular measurement task. Preferably, this activation pattern has a high density in the area of maximum sharpness of the optics (far field) and reduced density in the blurred area (near field).

Preferably, these pulse lines must have an appropriate distance between each other and to static signal lines on the integrated circuit 2 to keep pulse transit times as short as possible.

In order to increase area utilization and light yield, each macropixel may comprise a plurality of subpixels, each of which is connected to a common pulse line (logical OR).

Since statistical defects and response times of the subpixels are to be assumed, individual subpixels may be switched off so as not to interfere with the measurement.

In order to reduce the quantity of data to be transmitted between the sensor arrays 3, 4 and a computing unit (e.g., microcontroller 26), the count results of a plurality of pixels with similar illumination may be combined into a “superpixel”. In addition, the quantity of data may be reduced by calculating the phase and energy of the pixels prior to transmission. The data format preferably comprises the real part, imaginary part, and energy as a standard floating-point number, but could also be a fixed-point format adapted to the expected light intensities, amplitudes and tolerable phase errors.

FIG. 4 schematically illustrates a method 100, a device 10, a storage medium 15 and a computer program 20 according to exemplary embodiments of the disclosure.

FIG. 4 shows, in particular, an exemplary embodiment of a method 100 for performing a laser distance measurement with a laser distance measuring device 1 according to the disclosure. In a first step 101, emission of light is initiated by a laser diode 5 of the laser distance measuring device 1 toward an object 7 and an internal reference object 8. In a second step 102, sensor data of a first sensor array 3 and a second sensor array 4 is evaluated to determine a distance between the laser distance measuring device 1 and the object 7.

The foregoing explanation of the exemplary embodiments describes the present disclosure exclusively in the context of examples. Of course, individual features of the embodiments can be freely combined with one another, if technically feasible, without leaving the scope of the present disclosure.

What is claimed is:

1. An integrated circuit for a laser distance measuring device, comprising:
a first sensor array, wherein the first sensor array is configured to sense a light of a laser diode of the laser distance measuring device reflected by an object;
a second sensor array, wherein the second sensor array is configured to sense the light of the laser diode reflected by an internal reference object, wherein the second sensor array has a smaller size than the first sensor array; and
a barrier element, wherein the barrier element is arranged between the first sensor array and the second sensor array to counteract light transmission between the first sensor array and the second sensor array.

2. The integrated circuit according to claim 1, wherein the barrier element is comprised of an opaque material.

3. The integrated circuit according to claim 1, further comprising a glass surface, wherein:
the glass surface is arranged over the first sensor array and the second sensor array to cover the first sensor array and the second sensor array with the glass surface.

4. The integrated circuit according to claim 3, wherein the glass surface comprises an anti-reflective coating to increase light yield.

5. The integrated circuit according to claim 3, wherein the glass surface comprises a color filter configured to block a defined light wavelength spectrum.

6. The integrated circuit according to claim 1, wherein individual sensor surfaces of the first sensor array and/or the second sensor array have a polygonal shape.

7. The integrated circuit according to claim 6, wherein the individual sensor surfaces of the first sensor array and/or the second sensor array are partially configured as macropixels, each comprising a plurality of subpixels, and wherein the subpixels are connected to a common line.

8. A laser distance measuring device, comprising:
at least one integrated circuit according to claim 1; and
a laser diode.

9. A method for performing a laser distance measurement with the laser distance measuring device according to claim 8, comprising:
initiating emission of light by a laser diode of the laser distance measuring device toward an object and an internal reference object; and
evaluating sensor data of a first sensor array and a second sensor array to determine a distance between the laser distance measuring device and the object.

10. The method according to claim 9, wherein:
as part of evaluating the sensor data, count results of a plurality of pixels of the first sensor array and/or the second sensor array are added in phase to provide spatial averaging.

11. The method according to claim 9, wherein evaluating the sensor data comprises:
calculating an energy and/or a signal vector based on count results of each pixel.

12. The method according to claims 9, wherein evaluating the sensor data comprises:
evaluating individual macropixels by way of a multiphase counter, wherein a reading direction is perpendicular to a parallax direction.

13. A computer program, comprising instructions which, when the computer program is executed by at least one computer, cause the latter to execute the method according to claim 9.

14. A device for data processing that is configured to execute the method according to claim 1.

15. A computer-readable storage medium comprising instructions which, when executed by at least one computer, prompt the at least one computer to perform the steps of the method according to claim 1.

16. The integrated circuit according to claim 2, wherein the opaque material includes plastic or metal.

17. The integrated circuit according to claim 6, wherein the polygonal shape includes a rectangular shape.

18. The integrated circuit according to claim 17, wherein the rectangular shape is a square shape.
